(19) United States
(12) Patent Application Publication
(10) Pub. No.: US 2007/0023130 A1
(43) Pub. Date: Feb. 1, 2007

(54) Process for making a retarder and a polarizer having the retarder

(75) Inventors: Hong Wei Duz, Pingzhen City (TW); Chang Ching Sen, Pingzhen City (TW); Wu Long Hai, Pingzhen City (TW)

Correspondence Address: TROXELL LAW OFFICE PLLC, SUITE 1404, 5205 LEESBURG PIKE, FALLS CHURCH, VA, 22041, US

(73) Assignee: OPTIMAX Technology Corporation

(21) Appl. No.: 11/370,031

(22) Filed: Mar. 8, 2006

(30) Foreign Application Priority Data
Jul. 29, 2005 (TW) 094125717

(51) Int. Cl. B32B 27/00; B05D 3/00; C08F 2/46; C08J 7/18

(52) U.S. Cl. 156/163; 428/411.1; 427/553; 427/402; 427/487; 156/273.3

(57) ABSTRACT

A process for making retarder film characterized by laminating onto a substrate in sequence an alignment layer and a retardation material. In the process where the alignment layer of the retarder film is cured by ultraviolet light to undergo crosslinking reaction, the alignment layer is exposed to air or inert gas (with oxygen content no less than 1%) and provided with O.5 wt %˜10 wt % photoinitiator to achieve better adhesion to the substrate. At the same time, proper amount of active acrylate residue is left on the surface of alignment layer to facilitate subsequently the adhesion of retardation material thereon. This process results in polarizer with built-in retarder. Consequently, not only the polarizer has larger viewing ranges and better displaying quality because of the effect of optical compensation, the thickness of the polarizer is also smaller, and its transparency and optic characteristics are better than prior art.

### BACKGROUND OF INVENTION

1. Field of the Invention

The present invention relates to a process for making retarder film and a polarizer having the same, in particular a kind of retarder film suitable for the polarizer of LCD device and able to provide dual compensation for visual range and chromatic polarization, and its process.

2. Description of the Prior Art

Liquid crystal display (LCD) is now used by all kinds of electronic devices, such as television, computer, mobile handset, and personal digital assistant (PDA). Due to its characteristics of fast response and high contrast ratio of direct viewing angle, thin-film resistor LCD (TFT-LCD) has become the mainstream LCD technology.

FIG. 1 depicts the sectional view of a conventional LCD 10, which typically comprises a liquid crystal element 11 and two polarizers 12, 13 disposed respectively on each surface of liquid crystal element 11. The liquid crystal element 11 is constituted by a glass substrate and a plurality of liquid crystal cells adhered to both surfaces of the glass substrate. Polarizer 12 (or 13) is made of a polarizing film 123 (or 133) sandwiched between two transparent substrates 121, 122 (or 131, 132) that provides compensation for polarization.

If we look at the contrast curve of the visible range of a conventional LCD 10 (FIG. 1A) as shown in FIG. 1B, it is clear that conventional LCD offers good visual effect in vertical and horizontal directions only. At 45° or 135° angle, the contrast ratio drops and the hues shift, which seriously affects the display quality of LCD.

Later on LCDs are added with a retarder film to enhance the visual effect of oblique angles. FIG. 2 shows the flow process of adding a retarder film to a conventional LCD polarizer 20. Conventional LCD polarizer 20 is an independent plate or sheet structure made of a polarizing film 22 sandwiched between two transparent substrates 211, 212 (as shown in step 291). In addition, an independent structure of first phase retarder 24 is formed by coating on a substrate 241 in sequence an alignment layer 242 and liquid crystal material 243 (as shown in step 292). Similarly a second phase retarder 25 can also be formed independently (as shown in step 293). The first and the second phase retarders 24, 25 work to retard certain wavelengths at predetermined angles and directions, thereby achieving the effect of optical compensation and improving the oblique-angle display quality of LCD. In the prior art, polarizer 20, first phase retarder 24 and second phase retarder 25 are three separate elements that are respectively produced, stored, shipped and sold. By coating a layer of pressure sensitive adhesive (PSA) 231 on one of the transparent substrates 211 of polarizer 20, the first phase retarder 24 is laminated to the transparent substrate 211 in a manner with its liquid crystal material 243 facing down and its substrate 241 facing up (as shown in step 294). Subsequently, substrate 241 is stripped, and the combination of alignment layer 242 and liquid crystal material 243 is referred to as first phase retarder 24, which is adhered to the polarizer 20 via the PSA 231 (as shown in step 295). Subsequently, the first phase retarder 24 and second phase retarder 25 are respectively coated with PSA 232, 233 to adhere second phase retarder 25 to first phase retarder 24. As shown in step 296, a conventional LCD polarizer 20 having the function of optical compensation is formed and can be used in liquid crystal element 11 as shown in FIG. 1 to constitute a liquid crystal display. For example, U.S. Pat. No. 6,717,642 discloses a technology of improving the viewing angle and display quality of LCD by adding a retarder plate.

In the prior art LCD as shown in FIG. 2, polarizer 20 and phase retarders 24, 25 are separately produced and then laminated together with PSA. In light that the separately produced polarizer 20 and phase retarders 24,25 require respectively at least one transparent substrate 211 or substrate 241 to provide adequate structural strength and rigidity, and at least three layers of PSA 231, 232, 233 for adhesion, the use of many substrates and layers of PSA increase the thickness of LCD and affect adversely its transparency and optic characteristics, hence leaving room for improvement.

### SUMMARY OF INVENTION

The primary object of the present invention is to provide a process for making retarder film, characterized in which in the process of irradiating the alignment layer with ultraviolet light to produce crosslinking reaction, the alignment layer is exposed to air or inert gas (with oxygen content no less than 1% of volume percentage) and provided with 0.5 wt %˜10 wt % of weight percentage of photoinitiator. As such, proper amount of active acrylate residue is left on the surface of alignment layer to facilitate the lamination of retardation material thereon.

Another object of the present invention is to provide a process for making polarizer with retarder film, where the retardation layer in the retarder film is directly built in the polarizer without the use of pressure sensitive adhesive for adhesion. As such, the polarizer achieves better viewing angle and display quality due to the effect of optical compensation, and is reduced in thickness with at least one less layer of transparent substrate, hence offering better transparency and optic characteristics.

Yet a further object of the present invention is to provide a polarizer with retarder film, where the retardation layer in the retarder film is directly built in the polarizer according to the aforesaid process. As such, the polarizer achieves better viewing angle and display quality due to the effect of optical compensation, and is reduced in thickness as compared to prior art, hence offering better transparency and optic characteristics.

To achieve the aforesaid objects, the present invention provides a process for making retarder film, comprising the steps of:

providing a transparent substrate for coating the polarizing film;

coating an alignment layer on said transparent substrate;

irradiating the alignment layer with ultraviolet light using 0.5 wt %˜10 wt % (weight percentage) of photoinitiator and in an air or inert gas environment with oxygen content of at least 1% of volume percentage such that the incompletely reacted active acrylate is left on the surface of alignment layer;

coating retardation material on the alignment layer where the active acrylate residue thereon brings about closer adhesion of retardation material to the surface of alignment layer; and

under an air environment or inert gas, curing the alignment layer and retardation material with ultraviolet light.

### BRIEF DESCRIPTION OF THE DRAWINGS

The details of the present invention will be more readily understood from a detailed description of the preferred embodiments taken in conjunction with the following figures.

FIG. 1A shows the sectional view of a conventional LCD.

FIG. 1B shows the contrast curve of viewing angles of conventional LCD in FIG. 1A.

FIG. 2 shows the flow process of adding a retarder film to a conventional LCD polarizer.

FIG. 3 shows the flow process for making an retarder film according to the present invention.

FIG. 4A and FIG. 4B are diagrams showing the actions in FIG. 3.

FIG. 5 is a diagram showing the adhesion of a plurality of retardation particles to the alignment layer coated on a transparent substrate under UV irradiation and >10 wt % photoinitiator in pure nitrogen.

FIG. 6 is a diagram showing the adhesion of a plurality of retardation particles to the alignment layer coated on a transparent substrate under UV irradiation and 0.5 wt %˜10 wt % photoinitiator in air.

FIG. 7 is a diagram showing the process for directly disposing the retarder film made according to the process flows depicted in FIG. 3, FIG. 4A and FIG. 4B on a polarizer replacing one of the transparent substrates thereon.

FIG. 8 is a diagram showing the process for laminating another retarder film on a polarizer with built-in retarder film made according to the flow process depicted in FIG. 7.

FIG. 9 is a diagram showing the process for making polarizer with built-in retarder film with is an integration of the processes described in FIG. 3˜FIG. 8.

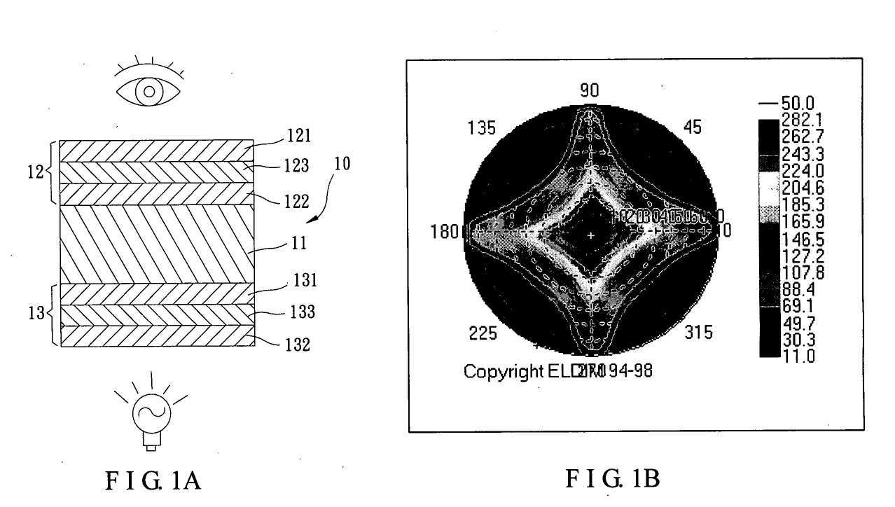

### DETAILED DESCRIPTION

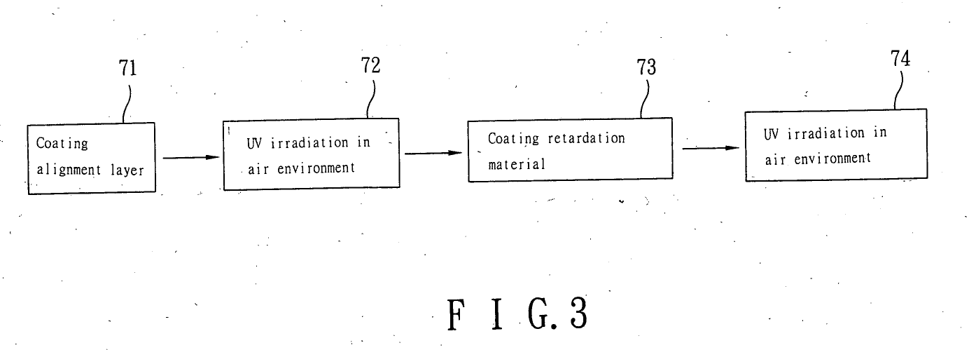

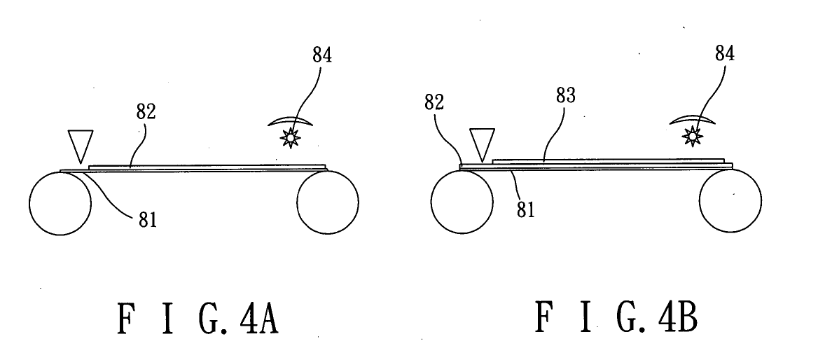

Referring to FIG. 3, FIG. 4A and FIG. 4B, the process for making retarder film 80 (also called a compensation film) according to the invention can be selectively implemented on a transparent substrate to form an independent retarder film or directly on a transparent substrate coated with polarizing film (i.e. directly implemented on the polarizer) to form a polarizer with retarder film. The process for making retarder film 80 as shown in FIG. 3 comprises the following steps:

Step 71: Coating an alignment layer 82 (as shown in FIG. 4A) on a transparent substrate 81. The alignment layer 82 contains at least oligomer. The transparent substrate 81 uses one of the transparent resin materials, including triacetyl cellulose (TAC), propionyl cellulose, and transparent resin, such as polyamide, polycarbonate, polyester, polystyrene, polyacrylate, norbomene-based polymer, and polyethyl acetate (PET). In considering that retarder film 80 is to be directly employed on a transparent substrate coated with polarizing film (i.e. directly employed on polarizer) or that retarder film 80 made according to the invention is to be used for coating or laminating a polarizing film, the transparent substrate 81 is preferably made of TAC due to its superior structural strength and rigidity that can support the entire polarizer structure and protect the polarizing film from scratches. In this embodiment, alignment layer 82 is mainly solvent-diluted oligomer (the solvent can be EAC, MeOH, IPA, MEK, or toluene on the market). The oligomer material can be Urethane or ester polymer based, such as UV-cured acrylate having an average molecular weight of 200˜4500, viscosity of 5000 cp˜100000 cp, and the number of functional group ranging preferably from two (bifunctional) to six (hexafunctional). Producers of such oligomer include UCB, Sartomer, and Kyoeisha.

In another embodiment, alignment layer 82 is added with an reactive monomer, or other additives, such as stabilizer or humectant. The monomer is in general mono- or bi-functional, UV-cured acrylate resin.

Step 72: Curing the alignment layer 82 with ultraviolet light 84 to cause crosslinking reaction. In this embodiment, UV curing takes place under radiation intensity of 30 mj/cm²˜1000 mj/cm², 0.5 wt % ˜10 wt % (weight percentage) of photoinitiator, and in air or inert gas with oxygen content of no less than 1% (volume percentage). Under those conditions, some incompletely reacted active acrylate is left over on the surface of alignment layer 82. The photoinitiator used can be a product available on the market, such as Irgacure 907, Irgacure 184, and Irgacure 369 by Ciba.

Step 73: Coating retardation material 83 on alignment layer 82 (as shown in FIG. 4B). The residual active acrylate on the surface of alignment layer 82 enables the plurality of retardation particles (e.g. liquid crystal cells) contained in the retardation material 83 (e.g. liquid crystal material) to adhere more easily to the surface of alignment layer 82. The retardation material 83 may be made of smectic or nematic UV-cured polymerizable mono- or bi-functional liquid crystal polymers. The technologies for retardation material 83 and plurality of liquid crystal cells are disclosed in UK patent GB2324382A.

Step 74: In an air or inert gas environment with oxygen content of no less than 1% of volume percentage, curing the alignment layer 82 and retardation material 83 with 30 mg/cm²˜1000 mj/cm² UV radiation.

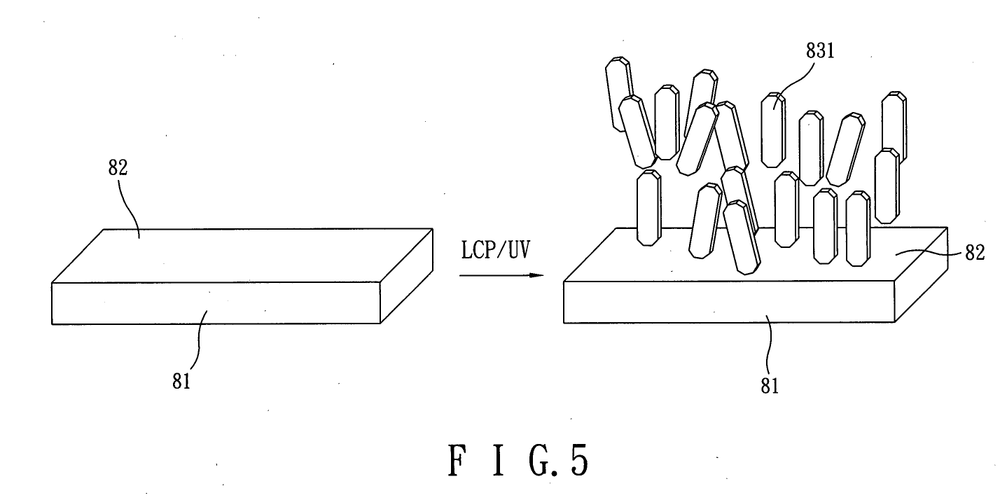

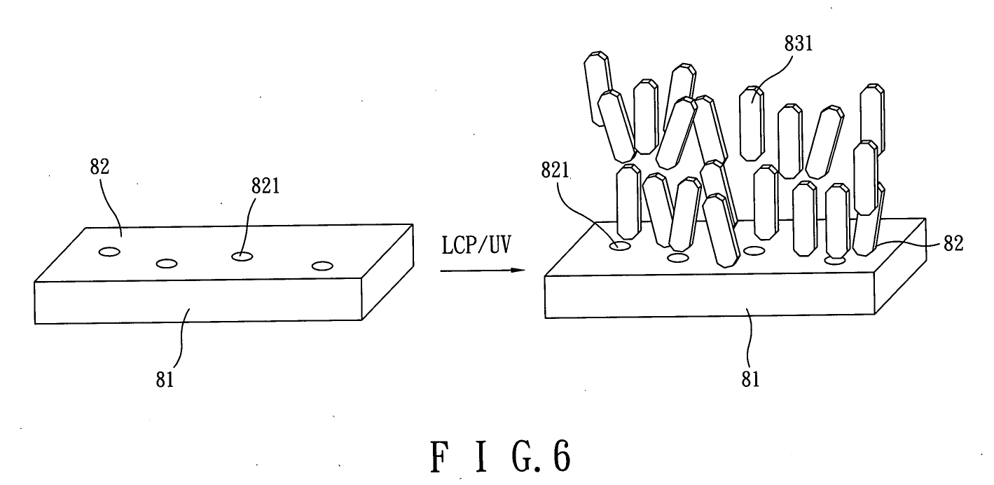

FIG. 5 and FIG. 6 are diagrams showing the adhesion of a plurality of retardation particles 831 (e.g. liquid crystal cells) to alignment layer 82 coated on a transparent substrate 81 under UV irradiation and >10 wt % photoinitiator in pure nitrogen, and under UV radiation and 0.5 wt %˜10 wt % (weight percentage) photoinitiator in air respectively. As shown in FIG. 5, when the transparent substrate 81 coated with alignment layer 82 is cured by UV in pure nitrogen and >10 wt % photoinitiator, there is little active acrylate left over on the surface of alignment layer 82 due to the complete crosslinking reaction of the oligomer. Thus although the resulting surface of alignment layer is flat and smooth, the adhesion of the plurality of retardation particles 831 to the surface is made more difficult. In comparison as shown in FIG. 6, when UV curing of transparent substrate 81 coated with alignment layer 82 takes place in air or a little inert gas (with oxygen content greater than 1% of volume percentage) with 0.5 wt %˜10 wt % (weight percentage) photoinitiator, the incompletely reacted active acrylate 821 would form tiny dents on the surface of alignment layer 82 that make it easier for retardation particles 831 (e.g. liquid crystal cells) to adhere to. In addition, retardation particles 831 adhere more strongly and more likely to arrange in a specific direction (e.g. vertical direction). As such, it becomes easier for the retardation particles 831 to adhere to alignment layer 82 in some kind of perpendicular orientation and results in retarder film 80 (or compensation film) of higher quality and greater stability. The present invention allows retarder film 80 to be directly configured on the polarizer without the need to produce it separately or worrying that the unstable quality of retarder film 80 might affect the yield of polarizer. Moreover, the present invention makes use of the incompletely reacted active acrylate 821 to make it easier for retardation particles 831 to adhere to alignment layer 82 in a specific direction without the need to add surfactant to alignment 82 for enhancement of adhesion. Thus as compared to the prior art disclosed in patent GB2324382A that employs surfactant, the present invention offers the advantages of lower cost and higher yield.

The inventor finds in experiments that under process conditions of 2 wt %˜5 wt % photoinitiator and nearly 20% oxygen content in air, the adhesion between retardation particles 831 and alignment layer 82 is further enhanced, hence resulting in retarder film 80 with more superior stability and optic characteristics.

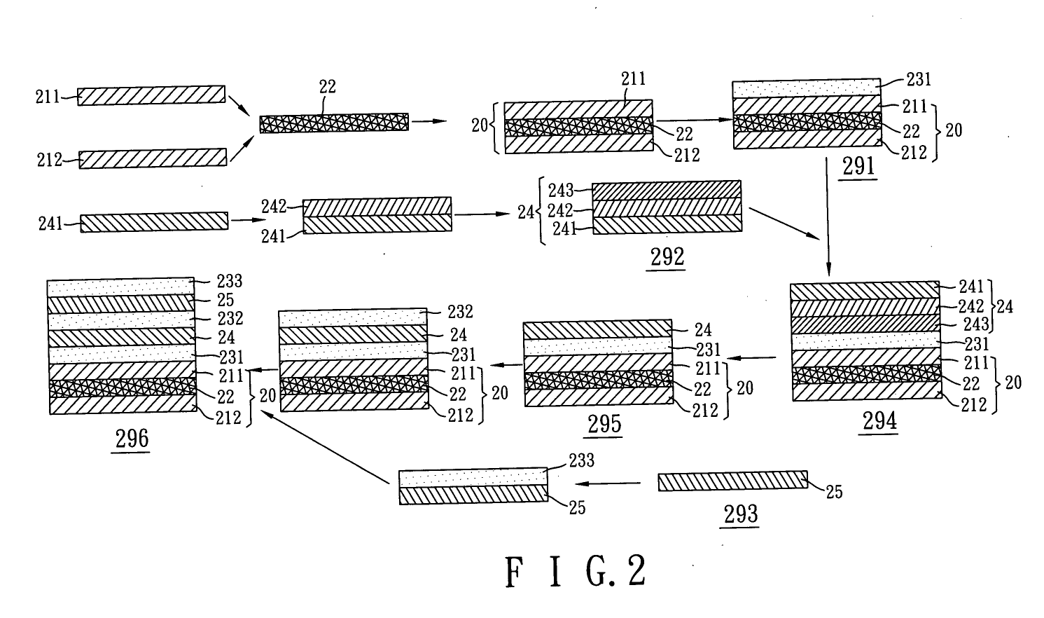

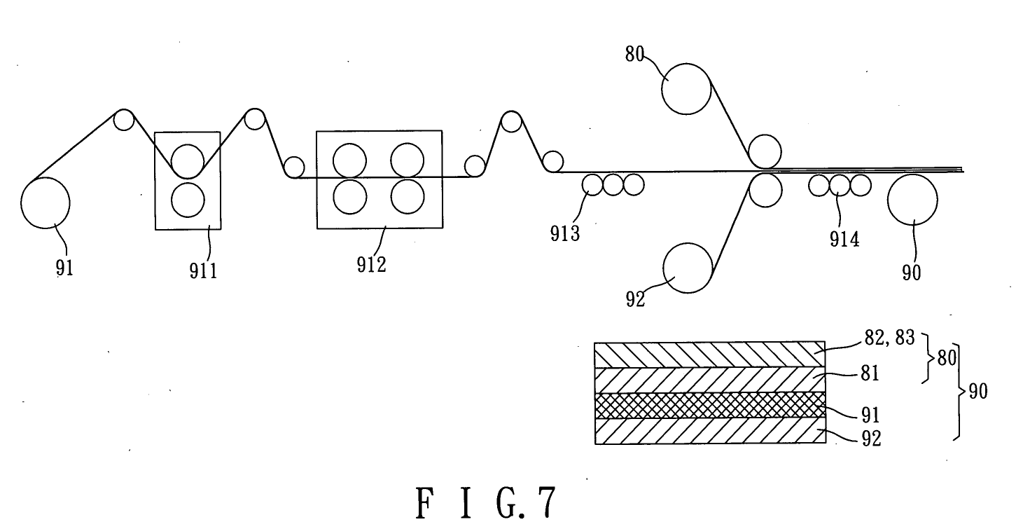

FIG. 7 is a diagram showing the process for directly disposing retarder film 80 made according to the process flows depicted in FIG. 3, FIG. 4A and FIG. 4B on a polarizer 90 replacing one of the transparent substrates thereon. As shown in FIG. 7, the retarder film 80 made is rolled into a tube. For the preparation of polarizing film, a PVA polarizing film 91 is first soaked in dichromatic dye 911 (e.g. iodine, potassium iodide, and other dichromatic dye) and then stretched in a predetermined direction and deformation range with a stretching device 912 to give polarizing film 91 specific polarizing effect. The aforesaid retarder film 80 in tube shape and a transparent substrate 92 (e.g. TAC substrate) are respectively laminated to each surface of polarizing film 91 in an oven 913, 914 to result in a polarizer 90 with built-in retarder film 80. In light that the retarder film 80 (including transparent substrate 81 coated with alignment layer 82 and retardation material 83) is directly disposed on polarizer 90, there is no need to employ an additional transparent substrate, or PSA, or any other material between retarder film 80 and polarizer 90. The polarizer 90 provided by the invention not only offers optical compensation with its built-in retarder film 80, the transparent substrate 81 of the retarder film 80 can provide a protective layer to the surface of polarizing film 91. Thus the polarizer 90 with built-in retarder film 80 according to the invention has at least one less layer of PSA or TAC substrate as compared to prior art shown in FIG. 2. It is therefore thinner and offers better transparency and optic characteristics.

In this embodiment, the retarder film 80 is preferably a retarder film that satisfies the conditions of nx=ny<nz and Rth=−10˜−300 nm (referred to as C+Plate). In addition, the retarder film 80 possesses even better optic characteristics when its Rth is confined to Rth=−30˜−80 nm, where nx denotes the refractive index along x-axis of film surface; ny denotes the refractive index along y-axis of film surface; nz is thicknesswise refractive index along z-axis; Rth={(nx+ny)/2−nz}*d; and d is film thickness.

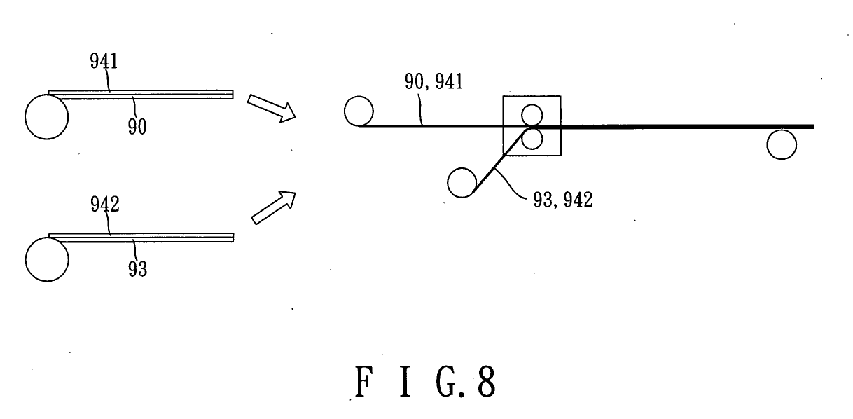

FIG. 8 is a diagram showing the process for laminating another retarder 93 on a polarizer 90 with built-in retarder film 80 made according to the flow process depicted in FIG. 7. First, another retarder film 93 (referred to as first phase retarder 93 hereunder) is provided. The first phase retarder 93 is a film that satisfies the conditions of nx>ny=nz and Ro=0.1˜220 nm (called A-Plate), where Ro=(nx−ny)*d. In a preferred embodiment, the first phase retarder 93 possesses even better optic characteristics when its Ro is further confined to Ro=80˜130 nm. The retarder film 80 and first phase retarder 93 can retard specific wavelengths at predetermined angles and directions to achieve the purpose of optical compensation, and hence better display quality in oblique angles. Next applying a layer of pressure sensitive adhesive 941 (e.g. PSA) on the top surface of polarizer 90 with built-in retarder film 80 (e.g. the surface having retarder film 80) and a layer of pressure sensitive adhesive 942 on the surface of first phase retarder 93 opposite the other surface of polarizer 90. Then laminating first phase retarder 93 onto the polarizer 90 with built-in retarder film 80 to form a polarizer suitable for use in in-plane switching (IPS)LCD. In this embodiment, the polarizer 90 has two layers of retarder film 80, 93 to provide even better optical compensation effect.

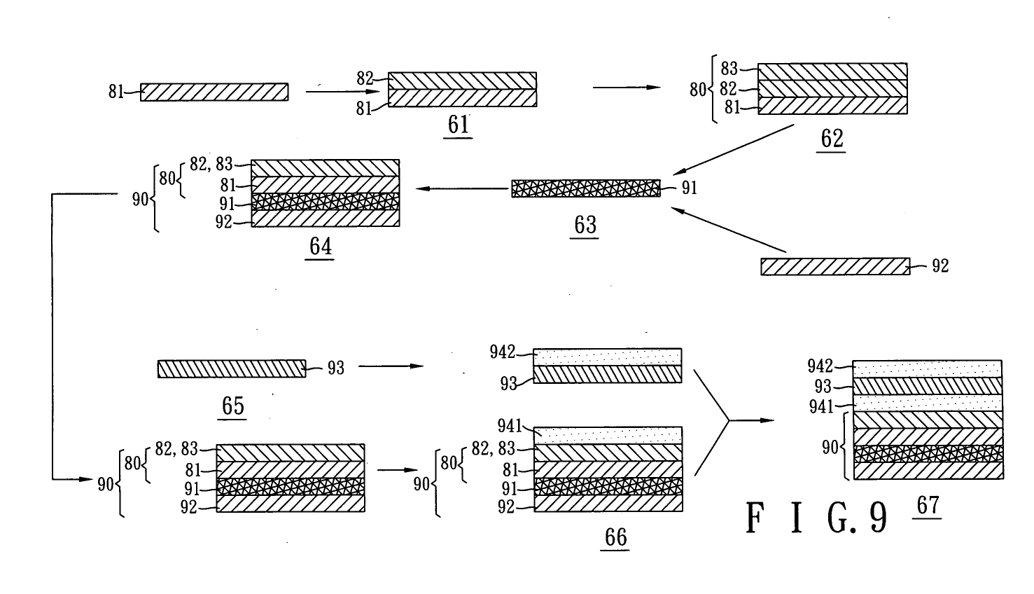

FIG. 9 is a diagram showing the process for making polarizer with built-in retarder with is an integration of the processes described in FIG. 3˜FIG. 8.

As shown in FIG. 9, the process for polarizer with optical compensation function according to the invention includes the following steps:

Step 61: Coating an alignment layer 82 on a transparent substrate 81, and curing the alignment layer 82 with 30 mj/cm²˜1000 mj/cm² UV and 0.5 wt %˜10 wt % photoinitiator, and in an air or inert gas environment with oxygen content of no less than 1% of volume percentage to leave some incompletely reacted active acrylate on the surface of alignment layer 82.

Step 62: Coating retardation materials 83 (e.g. liquid crystal material) on alignment layer 82 where the residue of active acrylate on the surface of alignment layer 82 makes the adhesion of a plurality of retardation particles (e.g. liquid crystal cells) contained in retardation material 83 to the alignment layer 82 easier. Subsequently, UV curing the alignment layer and retardation material under inert gas or air environment. The alignment layer coated with retardation material can retard specific wavelengths at predetermined angles and directions to achieve the effect of optical compensation.

Step 63: Providing a dye-containing polarizing film 91. Subsequently stretching said polarizing film in a predetermined direction and deformation range to give it specific polarizing effect.

Step 64: Laminating transparent substrate 81 coated with alignment layer 82 and retardation material 83 and another transparent substrate 92 onto the top and bottom surfaces of polarizing film 91 respectively. The two transparent substrates 81, 92 provide relatively high rigidity and structural strength as the protective layers of polarizing film 91.

Step 65: Providing another retarder film 93 (i.e. first phase retarder 93).

Step 66: Laminating the first phase retarder 93 onto transparent substrate 81 coated with alignment layer 82 and retardation material 83 using a pressure sensitive adhesive 941. The side of first phase retarder 93 farther away from the polarizer 90 is also coated with pressure sensitive adhesive 942 for adhering glass and polarizer.

As such, a polarizer 90 with built-in retarders 80, 93 that offers optical compensation as shown in step 67 is completed.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. A process for making retarder film, comprising the steps of:
(A) coating an alignment layer on a transparent substrate;
(B) irradiating the alignment layer with ultraviolet light under 0.5 wt %˜10 wt % photoinitiator and in an environment with oxygen content of at least 1% of volume percentage so that incompletely reacted active acrylate is left on the surface of alignment layer;
(C) coating retardation material on the alignment layer where the active acrylate residue thereon makes it easier for the plurality of retardation particles contained in the retardation material to adhere to the surface of alignment layer; and
(D) curing the alignment layer and retardation material with ultraviolet light;
where the retardation material in combination with alignment layer can retard specific wavelengths in predetermined angles and direction to achieve optical compensation.

2. The process for making retarder film according to claim 1, wherein said alignment layer contains at least oligomer compound and said oligomer compound can be UV-cured acrylate of Urethane or ester polymer based having an average molecular weight of 200˜4500, viscosity of 5000 cp˜100000 cp, and being bifunctional to hexafunctional.

3. The process for making retarder film according to claim 1, wherein the concentration of said photoinitiator is further confined in the range of 2 wt %˜5 wt %.

4. The process for making retarder film according to claim 1, wherein the intensity of ultraviolet irradiation ranges between of 30 mj/cm²˜1000 mj/cm², and said environment with oxygen content of at least 1% of volume percentage is an air or inert gas environment.

5. The process for making retarder film according to claim 1, wherein said transparent substrate is simultaneously disposed with a polarizing film thereon to provide the functions of optical compensation and polarization.

6. The process for making retarder film according to claim 1, wherein said transparent substrate coated with alignment layer and liquid crystal material is a retarder film (called C+Plate) that satisfies the condition of nx=ny<nz, where nx denotes the refractive index along x-axis of film surface; ny denotes the refractive index along y-axis of film surface; nz is thicknesswise refractive index along z-axis; and said retarder film (called C+Plate) further satisfies the condition of Rth=−30˜−80 nm, where Rth={(nx+ny)/2−nz}*d; and d is film thickness.

7. The process for making retarder film according to claim 1, further comprising the following steps subsequent to step (D):
(E) providing a polarizing film containing a dichromatic dye;
(F) stretching the polarizing film in predetermined direction and deformation range to let it exhibit specific polarizing effect; and
(G) laminating said transparent substrate coated with alignment layer and retardation material onto one surface of polarizing film;
wherein said transparent substrate coated with alignment layer and retardation material provides the effect of optical compensation, and can be used as a protective layer for the surface of polarizing film.

8. The process for making retarder film according to claim 7, further comprising the following steps subsequent to step (G):
(H) providing a first phase retarder that satisfies the condition of nx>ny=nz and is called A-Plate, where nx denotes the refractive index along x-axis of film surface; ny denotes the refractive index along y-axis of film surface; nz is thicknesswise refractive index along z-axis; and
(I) lamainating the first phase retarder onto said transaperent substrate coated with alignment layer and liquid crystal material using a pressure sensitive adhesive;
wherein said first phase retarder (A-Plate) further satisifes the condition of Ro=80˜130 nm, where Ro=(nx−ny)*d, and d is film thickness.

9. A process for making polarizer with retarder, comprising the steps of:
(a) providing a polarizer disposed with a polarizing film thereon;
(b) coating an alignment layer on said polarizer;
(c) irradiating the alignment layer with ultraviolet light under 0.5 wt %˜10 wt % photoinitiator and in an environment with oxygen content of at least 1% of volume percentage so that incompletely reacted active acrylate is left on the surface of alignment layer;
(d) coating retardation material on the alignment layer where the active acrylate residue thereon makes it easier for the plurality of retardation particles contained in the retardation material to adhere to the surface of alignment layer; and
(e) curing the alignment layer and retardation material with ultraviolet light;
where the retardation material in combination with alignment layer can retard specific wavelengths in predetermined angles and direction to achieve optical compensation.

10. A polarizer fabricated by the process of claim 9.

11. The polarizer according to claim 10, comprising:
a first transparent substrate to provide structural strength and rigidity for the polarizer;
a polarizing film formed on said first transparent substrate; and
at least a retarder film disposed directly on the polarizing film such that the first transparent substrate, the polarizing film and the retarder film together constitute one body.
